(19) United States
(12) Patent Application Publication
(10) Pub. No.: US 2018/0312006 A1
(43) Pub. Date: Nov. 1, 2018

(54) Pneumatic Tire, Having Working Layers Comprising Monofilaments And A Tire Tread With Grooves

(71) Applicant: COMPAGNIE GENERALE DES ETABLISSEMENTS MICHELIN, Clermont-Ferrand (FR)

(72) Inventors: Aymeric BONNET, Clermont-Ferrand Cedex 9 (FR); Jean-Charles DEROBERT-MAZURE, Clermont-Ferrand Cedex 9 (FR); Jacques MOREL-JEAN, Clermont-Ferrand Cedex 9 (FR)

(21) Appl. No.: 15/771,572

(22) PCT Filed: Oct. 26, 2016
(86) PCT No.: PCT/EP2016/075725

§ 371 Date: Apr. 27, 2018

(30) Foreign Application Priority Data
Oct. 27, 2015 (FR) 1560236

(51) Int. Cl. B60C 9/22; B60C 11/04; B60C 11/12; B60C 9/00

(52) U.S. Cl. CPC B60C 9/22; B60C 11/04; B60C 2011/036; B60C 9/0064; B60C 11/1281

(57) ABSTRACT

Technique to increase the endurance of tires comprising two crossed working layers (41, 42), comprising mutually parallel reinforcing elements forming, with the circumferential direction (XX′) of the tire, an angle which is at least equal to 20° and at most equal to 50°. The reinforcing elements are made up of individual metal threads or monofilaments having a cross section which is at least equal to 0.20 mm and at most equal to 0.5 mm. The tire also comprises grooves comprising a radially inferior zone Z1 having a radial height h1 equal to D/3, and a radially superior zone Z2 having a radial height h2 equal to 2D/3. These grooves have a mean width W at least equal to 1 mm and a depth D at least equal to 5 mm, and a maximum width W1 of zone 1, at least equal to 2 mm and a width of zone 2 at most equal to 1 mm.

### FIELD OF THE INVENTION

The present invention relates to a passenger vehicle tire, and more particularly to the crown of such a tire.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

A tire comprises a crown comprising a tread that is intended to come into contact with the ground via a tread surface, two beads that are intended to come into contact with a rim, and two sidewalls that connect the crown to the beads. Furthermore, a tire comprises a carcass reinforcement, comprising at least one carcass layer, radially on the inside of the crown and connecting the two beads.

The tread of a tire is delimited, in the radial direction, by two circumferential surfaces of which the radially outermost is referred to as the tread surface and of which the radially innermost is referred to as the tread pattern bottom surface. In addition, the tread of a tire is delimited, in the axial direction, by two lateral surfaces. The tread is also made up of one or more rubber compounds. The expression “rubber compound” refers to a composition of rubber comprising at least one elastomer and a filler.

The crown comprises at least one crown reinforcement radially on the inside of the tread. The crown reinforcement comprises at least one working reinforcement comprising at least one working layer made up of mutually parallel reinforcing elements that form. with the circumferential direction, an angle of between 15° and 50°. The crown reinforcement may also comprise a hoop reinforcement comprising at least one hooping layer made up of reinforcing elements that form, with the circumferential direction, an angle of between 0° and 10°, the hoop reinforcement usually, although not necessarily, being radially on the outside of the working layers.

What is meant by the “tread” of a tire is a quantity of one or more rubbery materials which is delimited by lateral surfaces and by two main surfaces, one of which is intended to come into contact with a roadway when the tire is running. This surface is referred to as the tread surface. The other surface, radially on the inside of the first, is referred to as the tread bottom surface.

In order to obtain good grip on wet ground, cuts are made in the tread. A cut denotes either a well, or a groove, or a sipe, or a circumferential groove and forms a space opening onto the tread surface. On the tread surface, a well has no characteristic main dimension. A sipe or a groove has, on the tread surface, two characteristic main dimensions: a width W and a length Lo, such that the length Lo is at least equal to twice the width W. A sipe or a groove is therefore delimited by at least two main lateral faces determining its length Lo and connected by a bottom face, the two main lateral faces being distant from one another by a non-zero distance referred to as the width W of the sipe or of the groove.

By definition, a sipe or a groove which is delimited by:
only two main lateral faces is said to be open-ended,
by three lateral faces, two of them being main faces determining the length of the cut, is said to be blind,
by four lateral faces, two of them being main faces determining the length of the cut, is said to be double-blind.

The difference between a sipe and a groove is the value of the mean distance separating the two main lateral faces of the cut, namely its width W. In the case of a sipe, this distance is suitable for allowing the mutually-facing main lateral faces to come into contact when the sipe enters the contact patch in which the tire is in contact with the road surface. In the case of a groove, the main lateral faces of this groove cannot come into contact with one another under usual running conditions. This distance for a sipe is generally, for passenger vehicle tires, at most equal to 1 millimetre (mm). A circumferential groove is a cut of substantially circumferential direction that is substantially continuous over the entire circumference of the tire.

More specifically, the width W is the mean distance, determined along the length of the cut and along a radial portion of the cut, comprised between a first circumferential surface, radially on the inside of the tread surface at a radial distance of 1 mm, and a second circumferential surface, radially on the outside of the bottom surface at a radial distance of 1 mm, so as to avoid any measurement problem associated with the junctions at which the two main lateral faces meet the tread surface and the bottom surface.

The depth of the cut is the maximum radial distance between the tread surface and the bottom of the cut. The maximum value of the depths of the cuts is referred to as the tread depth D. The tread pattern bottom surface, or bottom surface, is defined as being the surface of the tread surface translated radially inwards by a radial distance equal to the tread depth.

### PRIOR ART

In the current context of sustainable development, the saving of resources and therefore of raw materials is one of the industry's key objectives. For passenger vehicle tires, one of the avenues of research for achieving this objective is to replace the metal cords usually employed as reinforcing elements in various layers of the crown reinforcement with individual threads or monofilaments as described in document EP 0043563 in which this type of reinforcing element is used with the twofold objective of saving weight and lowering rolling resistance.

However, the use of this type of reinforcing element has the disadvantage of causing these monofilaments to buckle under compression, causing the tire to exhibit insufficient endurance, as described in document EP2537686. As that same document describes, a person skilled in the art proposes a particular layout of the various layers of the crown reinforcement and a specific quality of the materials that make up the reinforcing elements of the crown reinforcement in order to solve this problem.

An analysis of the physical phenomenon shows that the buckling of the monofilaments occurs in the axially outermost parts of the tread underneath the grooves, as mentioned in document JP 2012071791. This region of the tire has the particular feature of being subjected to high compression loadings when the vehicle is running in a curved line. The resistance of the monofilaments to buckling is dependent on the geometry of the grooves, thus demonstrating the surprising influence that the tread pattern has on the endurance of the monofilaments.

### SUMMARY OF THE INVENTION

The key objective of the present invention is therefore to increase the endurance of a tire the working layer reinforcing elements of which are made up of monofilaments, through the design of a suitable tread pattern for the tread.

This objective is achieved by a passenger vehicle tire comprising:
a tread intended to come into contact with the ground via a tread surface and having an axial width LT,
the tread comprising two axially exterior portions each having an axial width (LS1, LS2) at most equal to 0.3 times the axial width LT and each delimited axially on the inside by a circumferential groove,
at least one axially exterior portion comprising axially exterior grooves, an axially exterior groove forming a space opening onto the tread surface and being delimited by at least two faces referred to as main lateral faces connected by a bottom face,
at least one axially exterior groove, referred to as major groove, having a mean width W, defined by the mean distance between the two lateral faces, at least equal to 1 mm, a depth D, defined by the maximum radial distance between the tread surface and the bottom face, at least equal to 5 mm, and a curvilinear length L,
the axially exterior major grooves each comprising, over a portion of the curvilinear length L, a radially interior zone Z1 having a radial height h1 equal to D/3 and a maximum width W1 that is substantially constant, and a radially exterior zone Z2 having a radial height h2 equal to 2D/3 and a width W2,
the tire further comprising a crown reinforcement radially on the inside of the tread,
the crown reinforcement comprising a working reinforcement and a hoop reinforcement,
the working reinforcement comprising two working layers each comprising reinforcing elements which are coated in an elastomeric material, mutually parallel and respectively form, with a circumferential direction (XX′) of the tire, an oriented angle at least equal to 20° and at most equal to 50°, in terms of absolute value, and of opposite sign from one layer to the next,
the said working layer reinforcing elements being made up of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction (XX′) of the tire, an angle B at most equal to 10°, in terms of absolute value,
the axially exterior major grooves of the tread comprising, over at least 30% of their curvilinear length L, a radially interior zone Z1 having a maximum width W1 at least equal to 2 mm and a radially exterior zone Z2 having a width W2 at most equal to 1 mm over a radial height h3 at least equal to D/3,
the breaking strength R_{c} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

The intersection of the tread surface with the main lateral faces of a groove determines the main profiles of the groove. The main profiles of the grooves are usually intuitively identifiable because the intersection between the tread surface and the lateral faces of the grooves is a curve. In the case of tires in which the tread surface and the lateral faces of the grooves meet continuously, the profiles of the grooves are determined by the intersection between the main lateral faces of the grooves and the tread surface translated radially by −0.5 mm. The curvilinear length of a groove is calculated as the mean curvilinear length of the main profiles.

Usually, the main profiles of the groove are substantially of the same shape and distant from one another by the width W of the groove.

What is meant by the width of the groove is the mean distance between the main lateral faces, averaged over the mean curved length of the main profiles of the groove.

From a mechanical operation standpoint, the buckling of a reinforcing element occurs in compression. It occurs only radially on the inside of the axially outermost portions of the tread because it is in this zone that the compressive loadings are highest in the event of transverse loading. These axially outermost portions each have as their maximum axial width 0.3 times the total width of the tread of the tire.

Buckling is a complex and unstable phenomenon which leads to fatigue rupture of an object that has at least one dimension one order of magnitude smaller than a main dimension, such as beams or shells. Monofilaments are objects of this type with a cross section very much smaller than their length. The phenomenon begins when the main dimension is compressed. It continues because of the asymmetry of geometry of the monofilament, or because of the existence of a transverse force caused by the bending of the monofilament, which is a stress loading that is highly destructive for metallic materials. This complex phenomenon is notably highly dependent on the boundary conditions, on the mobility of the element and on the direction of the applied load and on the deformation resulting from this load. If this deformation does not take place substantially in the direction of the main dimension of the monofilament, then buckling will not occur and, in the case of monofilaments surrounded by a matrix of rubber compound of the working layers of a tire, the load is absorbed by the shearing of the rubber compound between the monofilaments.

In addition, the buckling of the monofilaments of the working layers occurs only under the axially exterior grooves of the tread because, in the absence of an axially exterior groove, the rubber material of the tread radially on the outside of the reinforcing element absorbs most of the compressive load. Likewise, the axially exterior grooves the depth of which is less than 5 mm, have no influence on the buckling of the monofilaments.

Moreover, the axially exterior grooves the width of which is less than 1 mm, referred to as sipes, close when they enter the contact patch and therefore protect the monofilaments from buckling. In the case of the grooves that are not axially exterior, the compressive loading in the case of transverse loading of the tire is too low to cause buckling. Moreover, it is common practice in passenger vehicle tires for only sipes of a width less than 1 mm to be arranged in the axially central parts of the tread.

The two axially exterior portions of the tread may contain one or more circumferential grooves in order to reduce the risk of aquaplaning on wet ground. In the case of tires, these grooves, representing a small width of the contact patch and have no known impact on the buckling of the monofilaments.

Therefore, only the axially exterior grooves referred to as major grooves, i.e. of a depth greater than 5 mm and a mean width greater than 1 mm need to be subjected to special design rules when using monofilaments in the working layers. These axially exterior major grooves are particularly essential to the wet grip performance of the tire.

In directions in which no empty space allows for movement, the compressive loadings will be absorbed by the rubber compound. When an axially exterior major groove is present, this groove does not absorb the load, but rather allows movements in compression in the direction perpendicular to the overall direction of its main lateral faces. In order to avoid buckling, it is necessary for the compressive load not to be applied to the reinforcing element but to be absorbed by an element of the tread pattern. However, it is necessary to maintain a void volume ratio when new and after wearing that is compatible with good wet grip performance. The shape of the grooves proposed by the inventors is such that in the new state, the radially exterior part of the groove, the width of which is at most equal to 1 mm, closes in the contact patch and therefore absorbs the compression loadings thus preventing the reinforcing elements of the working layers from buckling. As the tire becomes worn, the radially exterior part disappears leaving wide grooves, of a mean width at least equal to 1 mm, still capable of removing water when running over wet ground, but with a remaining groove depth that is such that the compression loading is no longer sufficient to cause the monofilaments of the working reinforcement to buckle.

The major grooves may also contain protuberances or bridges, these bridges being potentially able to contain a sipe with a mean width of less than 1 mm.

The monofilaments may have any cross-sectional shape, in the knowledge that oblong cross sections represent an advantage over circular cross sections, even when of smaller size, because their second moment of area in bending and, therefore, their resistance to buckling, are higher. In the case of a circular cross section, the smallest dimension corresponds to the diameter of the cross section. In order to guarantee the fatigue breaking strength of the monofilaments and the resistance to shearing of the rubber compounds situated between the filaments, the density of reinforcing elements of each working layer is at least equal to 100 threads per dm and at most equal to 200 threads per dm. What is meant by the density is the mean number of monofilaments over a 10-cm width of the working layer, this width being measured perpendicularly to the direction of the monofilaments in the working layer considered. The distance between consecutive reinforcing elements may be fixed or variable. The reinforcing elements may be laid during manufacture either in layers, in strips, or individually.

Furthermore, the resistance of a monofilament to buckling is also dependent on the resistance of the axially adjacent filaments, the onset of buckling in one being able to lead to the buckling of another through the effect of a distribution of load around the monofilament that is buckling. In order to obtain improved endurance performance, it is appropriate not only to observe monofilament density and diameter conditions but also to satisfy a condition relating to the strength of the working layer, namely the breaking strength R_{c} of each working layer which needs to be at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

For a tire for which no specific direction of mounting is imposed, the solution involves applying the invention to the two axially outermost portions of the tread.

For a tire for which a specific direction of mounting is imposed, one option is to apply the invention to only that axially outermost portion of the tread that is situated on the outboard side of the vehicle.

The tread patterns of passenger vehicle tires are usually either substantially symmetric or substantially antisymmetric, or substantially asymmetric.

It is advantageous for the axially exterior major grooves of the tread to comprise a radially interior zone Z1 having a width W1 at most equal to 8 mm so as to limit the void volume of the tread and preserve the wearability of the tire.

For reasons of ease of demoulding the tire during manufacture thereof, it is preferable for the axially exterior major grooves of the tread to comprise a radially exterior zone Z2 having a width W2 at least equal to 0.4 mm.

The axially exterior major grooves often have a depth less than 8 mm. This is because beyond a certain thickness of rubber, the tread becomes too flexible and the tire does not perform so well in terms of wear, behaviour and rolling resistance.

It is particularly advantageous for at least one axially exterior groove to open axially to the outside of the tread in order to remove water to the outside of the contact patch when running on a wet road surface.

Likewise, in order to improve grip performance, it is advantageous for at least one axially exterior groove to open axially onto the inside of a circumferential groove of the tread.

For preference, the axially exterior major grooves are spaced apart, in the circumferential direction (XX′) of the tire, by a circumferential spacing P at least equal to 8 mm, in order to avoid excessive flexibility of the tread and loss of wearing and rolling-resistance performance. The circumferential spacing is the mean circumferential distance, over the relevant axially outermost portion of the tread, between the mean linear profiles of two circumferentially consecutive axially exterior major grooves. Usually, the treads of tires may have circumferential spacings that are variable notably so as to limit road noise.

One preferred solution also consists in the axially exterior major grooves being spaced apart, in the circumferential direction (XX′) of the tire, by a circumferential spacing P at most equal to 50 mm, in order to guarantee, by having a sufficient tread void volume ratio, that the tire is able to grip on wet road surfaces.

It is particularly advantageous for the radial distance between the bottom face of the axially exterior grooves and the radially outermost reinforcing elements of the crown reinforcement to be at least equal to 1.5 mm. This is because this minimal quantity of rubbery material protects the crown from attack and puncturing by obstacles, stones, or any debris lying on the ground.

It is preferable for the radial distance between the bottom face of the axially exterior grooves and the radially outermost reinforcing elements of the crown reinforcement to be at most equal to 3.5 mm in order to obtain a tire that performs well in terms of rolling resistance.

It is advantageous for at least an axially exterior portion of the tread to comprise sipes having a mean width W at most equal to 1 mm. In order to improve grip on certain types of ground, notably on ground covered with black ice or snow, it is possible to provide small-width sipes in the axially exterior portions of the tread, without impairing the endurance of the tire the working reinforcement of which contains monofilaments. This is because when these sipes enter the contact patch, their main profiles come into contact with one another and the rubbery material of the tread then absorbs the compressive loadings.

It is also possible to provide grooves of small depth, smaller than 5 mm, without significantly impairing the endurance of the tire, although, in this case, the performance, notably wet grip performance, becomes degraded as the tire wears.

The two axially exterior portions of the tread each have an axial width (LS1, LS2) at most equal to 0.2 times the axial width LT of the tread.

For preference, each working layer comprises reinforcing elements made up of individual metal threads or monofilaments having a cross section the smallest dimension of which is at least equal to 0.3 mm and at most equal to 0.37 mm, which constitute an optimum for balancing the target performance aspects: weight saving and buckling endurance of the reinforcing elements of the working layers.

One preferred solution is for each working layer to comprise reinforcing elements which form, with a circumferential direction (XX′) of the tire, an angle of which the absolute value is at least equal to 22° and at most equal to 35°, which constitute an optimum between tire behaviour and tire endurance performance. The angles of the reinforcing elements of the working layers are measured at the equatorial plane.

It is advantageous for the density of reinforcing elements in each working layer to be at least equal to 120 threads per dm and at most equal to 180 threads per dm in order to guarantee improved endurance of the rubber compounds working in shear between the reinforcing elements and the tension and compression endurance thereof.

The reinforcing elements of the working layers may or may not be rectilinear. They may be preformed, of sinusoidal, zigzag, or wavy shape, or following a spiral. The reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably comprised in a range from 0.8% to 1.2%. The invention is particularly applicable to steels of the very high strength (referred to as “SHT” for “Super High Tensile”), ultra-high strength (referred to as “UHT” for “Ultra High Tensile” or “MT” for “Mega Tensile”) steel cord type. The carbon steel reinforcers then have a tensile breaking strength (Rm) preferably higher than 3000 MPa, more preferably higher than 3500 MPa. Their total elongation at break (At), which is the sum of the elastic elongation and the plastic elongation, is preferably greater than 2.0%.

As far as the steel reinforcers are concerned, the measurements of breaking strength, denoted Rm (in MPa), and elongation at break, denoted At (total elongation in %), are taken under tension in accordance with ISO standard 6892 of 1984.

The steel used, whether it is in particular a carbon steel or a stainless steel, may itself be coated with a layer of metal which improves for example the workability of the steel monofilament or the wear properties of the reinforcer and/or of the tire themselves, such as properties of adhesion, corrosion resistance or even resistance to ageing. According to one preferred embodiment, the steel used is covered with a layer of brass (Zn—Cu alloy) or of zinc; it will be recalled that, during the process of manufacturing the wire threads, the brass or zinc coating makes the wire easier to draw, and makes the wire thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

For preference, the reinforcing elements of the at least one hooping layer are made of textile of aliphatic polyamide, aromatic polyamide or combination of aliphatic polyamide and of aromatic polyamide, polyethylene terephthalate or rayon type, because textile materials are particularly well-suited to this type of use as they are lightweight and afford excellent rigidity. The distance between consecutive reinforcing elements in the hooping layer may be fixed or variable. The reinforcing elements may be laid during manufacture either in layers, in strips, or by reinforcing element.

It is advantageous for the hoop reinforcement to be radially on the outside of the working reinforcement in order to ensure good endurance of the latter.

### BRIEF DESCRIPTION OF THE DRAWINGS

The features and other advantages of the invention will be understood better with the aid of FIGS. 1 to 7, the said figures being drawn not to scale but in a simplified manner so as to make it easier to understand the invention:

FIG. 1 is a perspective view depicting part of the tire according to the invention, particularly its architecture and its tread.

FIG. 2 depicts a meridian section through the crown of a tire according to the invention and illustrates the axially exterior parts of the tread.

FIGS. 3A and 3B depict two types of radially exterior meridian profile of the tread of a passenger vehicle tire.

FIG. 4 illustrates various embodiments of axially exterior grooves according to the invention.

FIG. 5A, 5B, 5C illustrate a method for determining the major grooves in the case of a network of grooves.

FIG. 6 illustrates two types of siping for two examples of the tires A and B described hereinafter.

FIG. 7 illustrates the respective exterior and interior edges of a tread.

### DETAILED DESCRIPTION OF THE DRAWINGS

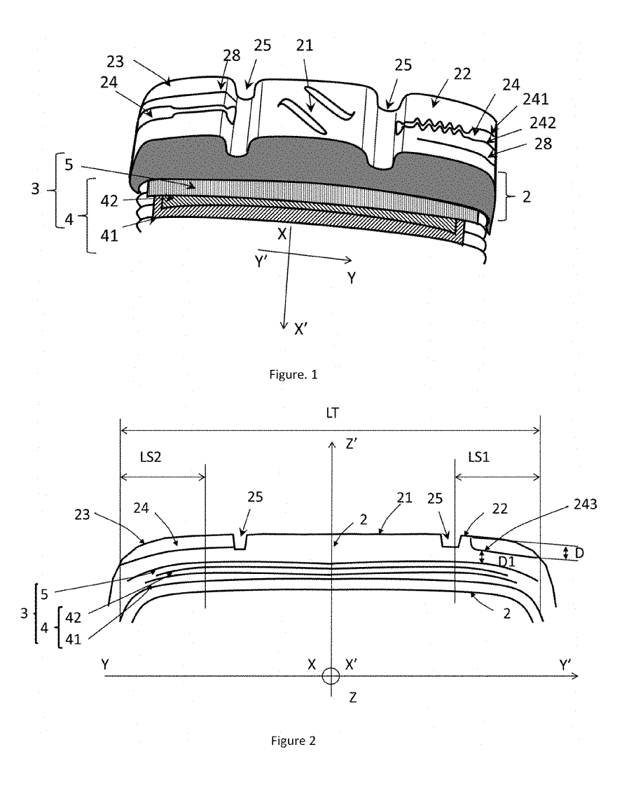

FIG. 1 is a perspective view depicting a part of the crown of a tire. The tire comprises a tread 2 which is intended to come into contact with the ground via a tread surface 21. In the axially exterior parts 22 and 23 of the tread there are axially exterior grooves 24. The tire further comprises a crown reinforcement 3 comprising a working reinforcement 4 and a hoop reinforcement 5. The working reinforcement comprises two working layers 41 and 42 each comprising reinforcing elements which are mutually parallel and respectively form, with a circumferential direction (XX′) of the tire, an oriented angle at least equal to 20° and at most equal to 50°, in terms of absolute value, and of opposite sign from one layer to the next.

FIG. 1 depicts in the axially exterior parts 22 and 23 of the tread, only axially exterior grooves, running along the axial axis (YY′). In reality, this depiction is pure convenience for the sake of the readability of FIG. 1, it being possible, depending on the performance aims, particularly in terms of wet grip, for the axially exterior grooves in the treads of passenger vehicles to make with the axial direction (YY′) an angle of between plus and minus 60°.

FIG. 2 is a schematic meridian section through the crown of the tire according to the invention. It illustrates in particular the widths LS1 and LS2 of the axially exterior parts 23 and 24 of the tread, and the total width of the tire LT. The depth D of an axially exterior groove 24, and the distance D1 between the bottom face 243 of any groove 24 and the crown reinforcement 3, measured along a meridian section of the tire, are also depicted. A meridian section of the tire is obtained by cutting the tire on two meridian planes. By way of example, a meridian section of tire has a thickness in the circumferential direction of around 60 mm at the tread. The measurement is taken with the distance between the two beads being kept identical to that of the tire mounted on its rim and lightly inflated.

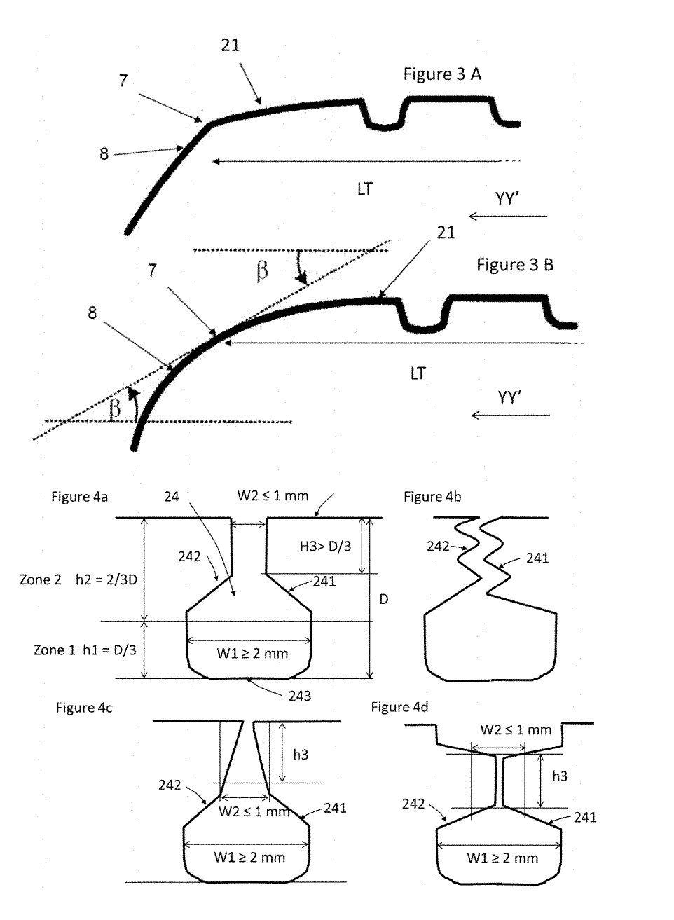

FIGS. 3A and 3B, depict the method for determining the axial edges 7 of the tread, that make it possible to measure the tread width. In FIG. 3A, in which the tread surface 21 is secant with the exterior axial surface of the tire 8, the axial edge 7 is determined by a person skilled in the art in a trivial way as being the point of intersection between the two surfaces. In FIG. 3B, in which the tread surface 21 extends the exterior axial surface of the tire 8 in a manner which, mathematically speaking, is continuous and differentiable, the tangent to the tread surface at any point on the said tread surface in the region of transition towards the sidewall is plotted on a radial section of the tire. The first axial edge 7 is the point for which the angle p between the said tangent and an axial direction is equal to 30°. When there are several points for which the angle p between the said tangent and an axial direction is equal to 30°, it is the radially outermost point that is adopted. The same approach is used to determine the second axial edge of the tread which is symmetrical with respect to the equatorial plane of the tire.

FIG. 4 schematically depicts cross sections, substantially perpendicular to the main lateral faces (241, 242) of the axially exterior grooves 24 in a tread 2 according to four different embodiments. The axially exterior grooves 24 comprises a radially interior zone Z1 having a radial height h1 equal to D/3 and a maximum width W1, and a radially exterior zone Z2 having a radial height h2 equal to 2D/3 and a width W2. FIG. 4a illustrates a first embodiment of a groove for which the width W2 of zone 2 is at most equal to 1 mm over a height at least equal to 0.33 D and the width W1 of zone 1 is at least equal to 2 mm. FIG. 4b illustrates a second embodiment of a groove for which the main lateral faces have special shapes intended to block their relative movements when they come into contact in the contact patch. These technologies of what is referred to as self-locking siping, whether they be self-locking in the radial direction as illustrated in FIG. 4b, in the overall direction of the groove as illustrated in FIG. 1 by the siping 24 on the axially exterior part 22, or in both of these two directions, are well known to those skilled in the art. The benefit of such solutions is that relative movements of the main lateral faces are blocked and specific wear forms detrimental to the performance of the tire are avoided. FIGS. 4c and 4d illustrate two other possible embodiments of axially exterior grooves 24.

FIGS. 5A, 5B, 5C illustrate a method for determining the major grooves in the case of a network of grooves. For certain tread patterns, grooves open into other grooves as illustrated in FIG. 5A. In that case, the lateral faces of the network which are the continuous lateral faces most circumferentially distant from one another in the network of grooves will be determined, which in the present case are the lateral faces 241 and 242. The invention will be applied to all the grooves which, as their lateral faces, have one of the lateral faces of the network and the directly adjacent opposite lateral face. Let us therefore consider here the groove 24_1 (FIG. 5B), of mean linear profile L_1, made up of the lateral face of the network 241 and the opposite lateral face directly adjacent to (241, 242′), over a first portion leading from point A to point B, and of the lateral face of the network 241 and the opposite lateral face 242 directly adjacent to 241, over a second portion leading from point B to point C. Next, consider the groove 24_2 (FIG. 5C), of mean linear profile L_2, made up of the lateral face of the network 242 and the opposite lateral face 241′ directly adjacent to 242, over a first portion leading from point A to point B, and of the lateral face of the network 242 and the opposite lateral face 241 directly adjacent to 242, over a second portion leading from point B to point C. For more complex networks, this rule will be generalized so that all of the possible major grooves of the network substantially following the orientation of the lateral faces of the network satisfy the characteristics of the invention.

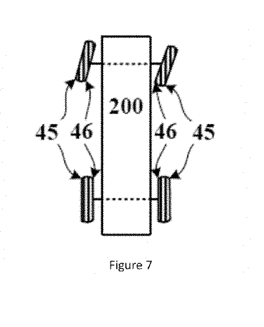

FIG. 7 schematically depicts tires which are intended to be mounted on mounting rims of wheels of a vehicle 200 and having a predetermined direction of mounting on the vehicle. Each tire comprises an exterior axial edge 45 and an interior axial edge 46, the interior axial edge 46 being the edge which is intended to be mounted on the bodyshell side of the vehicle when the tire is mounted on the vehicle in the said predetermined direction of mounting, and the exterior axial edge 45 being the opposite of that. In the document, “outboard side of the vehicle” denotes the exterior axial edge 45.

The inventors have performed calculations on the basis of the invention for a tire of size 205/55 R16, inflated to a pressure of 2 bar, comprising two working layers of steel monofilaments of diameter 0.3 mm and distributed at a density of 158 threads to the dm and forming, with the circumferential direction, angles respectively equal to 27° and −27°. The monofilaments have a breaking strength Rᵥ equal to 3500 MPa and the working layers each have a breaking strength R_{c} equal to 39 000 N/dm. The tire comprises axially exterior grooves of the blind type of a depth of 6.5 mm, on the two axially exterior portions of the tread of the tire having a width 0.2 times the width of the tread, distributed at a circumferential spacing of 27 mm. The radial distance D1 between the bottom face of the axially exterior major grooves and the crown reinforcement is at least equal to 2 mm.

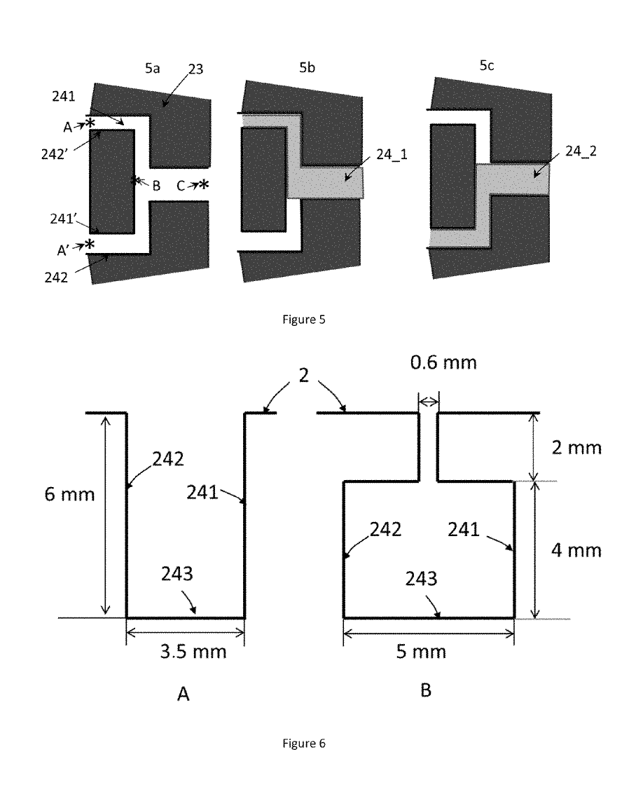

Tire A comprises grooves of rectangular section, having a depth equal to 6 mm, a width 3.5 mm and a cross section equal to 21 mm2, as illustrated in FIG. 6A. Tire B comprises grooves having a depth equal to 6 mm, which are rectangular in segments. The radially innermost zone 1 of the grooves of tire B has a maximum width W1 equal to 5 mm and a depth equal to 4 mm. The radially outermost zone 2 of the grooves of tire B has a width equal to 0.6 mm and a height equal to 2 mm. These grooves are illustrated in FIG. 6B. They satisfy the features of the invention. The cross section of these two types of grooves is equal to 21 mm2. The tires are calculated with a distance between each adjacent groove. The circumferential distance between two consecutive grooves is equal to 27 mm. The overall direction of the grooves is substantially axial.

The conditions used for the calculation reproduce the running conditions of a front tire on the outside of the bend, namely the tire that is most heavily loaded in a passenger vehicle. These loadings, for a lateral acceleration of 0.7 g, are as follows: a load (Fz) of 749 daN, a lateral load (Fy) of 509 daN and a camber angle of 3.12°. The shape of the grooves of tire B makes it possible to reduce the bending stresses in the monofilaments of the working reinforcement by 37% with respect to tire A comprising the type A grooves, these bending stresses being what causes them to rupture through fatigue. The shape of the major grooves of tire B therefore makes it possible to guarantee the monofilaments' superior endurance in relation to the major-grooves shape of tire A, while at the same time maintaining the same void volume ratio.

1. A fire for a passenger vehicle, comprising:
a tread adapted to come into contact with the ground via a tread surface and having an axial width LT,
the tread comprising two axially exterior portions each having an axial width at most equal to 0.3 times the axial width LT and each delimited axially on the inside by a circumferential groove,
at least one axially exterior portion comprising axially exterior grooves, an axially exterior groove forming a space opening onto the tread surface and being delimited by at least two faces referred to as main lateral faces connected by a bottom face,
at least one axially exterior groove, referred to as major groove, having a mean width W, defined by the mean distance between the two lateral faces, at least equal to 1 mm, a depth D, defined by the maximum radial distance between the tread surface and the bottom face, at least equal to 5 mm, and a curvilinear length L,
the axially exterior major grooves each comprising, over a portion of the curvilinear length L, a radially interior zone Z1 having a radial height h1 equal to D/3 and a maximum width W1 that is substantially constant, and a radially exterior zone Z2 having a radial height h2 equal to 2D/3 and a width W2,
the tire further comprising a crown reinforcement radially on the inside of the tread,
the crown reinforcement comprising a working reinforcement and a hoop reinforcement,
the working reinforcement comprising two working layers each comprising reinforcing elements which are coated in an elastomeric material, mutually parallel and respectively form, with a circumferential direction of the tire, an oriented angle at least equal to 20° and at most equal to 50°, in terms of absolute value, and of opposite sign from one layer to the next,
said working layer reinforcing elements being comprised up of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction of the tire, an angle B at most equal to 10°, in terms of absolute value,
wherein the the axially exterior major grooves of the tread, of depth D, comprise, over at least 30% of their curvilinear length L, a radially interior zone Z1 having a maximum width W1 at least equal to 2 mm and a radially exterior zone Z2 having a width W2 at most equal to 1 mm over a radial height h3 at least equal to D/3,
and wherein the breaking strength R_{c} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

2. The tire according to claim 1, wherein the axially exterior major grooves of the tread comprise a radially interior zone Z1 having a width W1 at most equal to 8 mm.

3. The tire according to claim 1, wherein the axially exterior major grooves of the tread comprise a radially exterior zone Z2 having a width W2 at least equal to 0.4 mm.

4. The tire according to claim 1, wherein at least one axially exterior groove opens axially on the outside of the tread.

5. The tire according to claim 1, wherein at least one axially exterior groove opens axially on the inside of a circumferential groove of the tread.

6. The tire according to claim 1, wherein the axially exterior major grooves are spaced apart, in the circumferential direction of the tire, by a circumferential spacing P at least equal to 8 mm.

7. The tire according to claim 1, wherein the axially exterior major grooves are spaced apart, in the circumferential direction of the tire, by a circumferential spacing P at most equal to 50 mm.

8. The tire according to claim 1, wherein the radial distance D1 between the bottom face of the axially exterior grooves and the radially outermost reinforcing elements of the crown reinforcement is at least equal to 1.5 mm.

9. The tire according to claim 1, wherein the radial distance D1 between the bottom face of the axially exterior grooves and the radially outermost reinforcing elements of the crown reinforcement is at most equal to 3.5 mm.

10. The tire according to claim 1, wherein at least an axially exterior portion of the tread comprises sipes having a mean width w at most equal to 1 mm.

11. The tire according to claim 1, wherein the two axially exterior portions of the tread each have an axial width at most equal to 0.2 times the axial width LT.

12. The tire according to claim 1, wherein each working layer comprises reinforcing elements made up of individual metal threads or monofilaments having a diameter at least equal to 0.3 mm and at most equal to 0.37 mm.

13. The tire according to claim 1, wherein each working layer comprises reinforcing elements which form, with a circumferential direction of the tire, an angle the absolute value of which is at least equal to 22° and at most equal to 35°.

14. The tire according to claim 1, wherein the density of reinforcing elements in each working layer is at least equal to 120 threads per dm and at most equal to 180 threads per dm.

15. The tire according to claim 1, wherein the reinforcing elements of the working layers are made of steel.

16. The tire according to claim 1, wherein the reinforcing elements of the at least one hooping layer are made of textile, aromatic polyamide or combination of aliphatic polyamide and of aromatic polyamide, polyethylene terephthalate or rayon type.

17. The tire according to claim 1, wherein the hoop reinforcement is radially on the outside of the working reinforcement.

18. The tire according to claim 15, wherein the steel is carbon steel.

19. The tire according to claim 16, wherein the textile is of aliphatic polyamide.
